(19) United States
(12) Patent Application Publication
(10) Pub. No.: US 2019/0061307 A1
(43) Pub. Date: Feb. 28, 2019

(54) FLEXIBLE WEB FOR CLOTHING

(71) Applicant: WISHER INDUSTRIAL CO., LTD., Taipei City (TW)

(72) Inventors: Chun-Chou CHEN, Taipei City (TW); Tsuo-Cheng HSIEH, Taipei City (TW); Chun-Ming LU, Taipei City (TW); Chi-Ling CHEN, Taipei City (TW)

(21) Appl. No.: 15/868,010

(22) Filed: Jan. 11, 2018

(30) Foreign Application Priority Data
Aug. 31, 2017 (TW) 106212906

(51) Int. Cl. B32B 3/26; B32B 7/12; B32B 27/40; B32B 27/32

(52) U.S. Cl. CPC B32B 3/266; B32B 7/12; B32B 2307/726; B32B 27/322; B32B 2437/00; B32B 27/40

(57) ABSTRACT

A flexible web for clothing comprises a fabric substrate and a lining piece unit. The fabric substrate layer has a plurality of slits which are displaced from each other and each of which includes a first slit segment and a second slit segment. The lining piece unit is made from an absorbent polymer and includes a plurality of lining pieces each of which has a first marginal edge and a second marginal edge, and each of which is configured such that when bonded to the fabric substrate layer, the first and second marginal edges respectively border at the first and second slit segments.

### CROSS-REFERENCE TO RELATED APPLICATION

This application claims priority of Taiwanese Application No. 106212906, filed on Aug. 31, 2017.

### FIELD

The disclosure relates to a flexible web for clothing, and more particularly to a flexible web for clothing which includes a plurality of lining pieces made from an absorbent polymer.

### BACKGROUND

Due to the continuously increasing demand for comfortability of clothing, fabric characteristics such as moisture absorbance, breathability, and the like have become issues which are widely researched. However, warmth preservation may be compromised in an attempt to provide clothing with moisture absorbance and breathability.

U.S. Pat. No. 7,754,626 discloses an article of apparel that includes a textile with at least one property that changes upon exposure to a physical stimulus. The textile has a modifiable structure formed from one or more yarns that exhibit a dimensional transformation upon exposure to the physical stimulus. The yarns have a first set of dimensions when unexposed to the physical stimulus, and the yarns have a second set of dimensions when exposed to the physical stimulus. The structure of the textile is modified by exposing the textile to the physical stimulus such that the yarns transform from the first set of dimensions to the second set of dimensions and change the property of the textile.

### SUMMARY

An object of the disclosure is to provide a flexible web for clothing which includes a plurality of lining pieces made from an absorbent polymer to regulate the breathability thereof.

According to the disclosure, there is provided a flexible web for clothing comprising a fabric substrate layer and a lining piece unit. The fabric substrate layer has a plurality of slits which are displaced from each other and each of which includes a first slit segment and a second slit segment. The lining piece unit is made from an absorbent polymer and includes a plurality of lining pieces each of which has a first marginal edge and a second marginal edge, and each of which is configured such that when bonded to the fabric substrate layer, the first and second marginal edges respectively border at the first and second slit segments.

### BRIEF DESCRIPTION OF THE DRAWINGS

Other features and advantages of the disclosure will become apparent in the following detailed description of the embodiment(s) with reference to the accompanying drawings, of which:

FIG. 1 is a perspective view of a first embodiment of a flexible web for clothing according to the disclosure in a state prior to water absorption;

FIG. 2 is a perspective view of the first embodiment in a state after water absorption;

FIG. 3 is a fragmentary sectional view of the first embodiment in a state prior to water absorption;

FIG. 4 is a fragmentary sectional view of the first embodiment in a state after water absorption;

FIG. 5 is a fragmentary sectional view of a second embodiment of a flexible web for clothing according to the disclosure in a state prior to water absorption;

FIG. 6 is a fragmentary sectional view of the second embodiment in a state after water absorption;

FIG. 7 is a schematic bottom view of the second embodiment;

FIG. 8 is a fragmentary sectional view of a third embodiment of a flexible web for clothing according to the disclosure in a state prior to water absorption;

FIG. 9 is a fragmentary sectional view of the third embodiment in a state after water absorption;

FIG. 10 is a schematic bottom view of the third embodiment;

FIG. 11 is a perspective view of a fourth embodiment of a flexible web for clothing according to the disclosure in a state prior to water absorption;

FIG. 12 is a perspective view of the fourth embodiment in a state after water absorption;

FIG. 13 is a perspective view of a fifth embodiment of a flexible web for clothing according to the disclosure in a state prior to water absorption;

FIG. 14 is a perspective view of the fifth embodiment in a state after water absorption;

FIG. 15 is a fragmentary sectional view of a sixth embodiment of a flexible web for clothing according to the disclosure;

FIG. 16 is a perspective view of a seventh embodiment of a flexible web for clothing according to the disclosure in a state prior to water absorption; and

FIG. 17 is a perspective view of the seventh embodiment in a state after water absorption.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

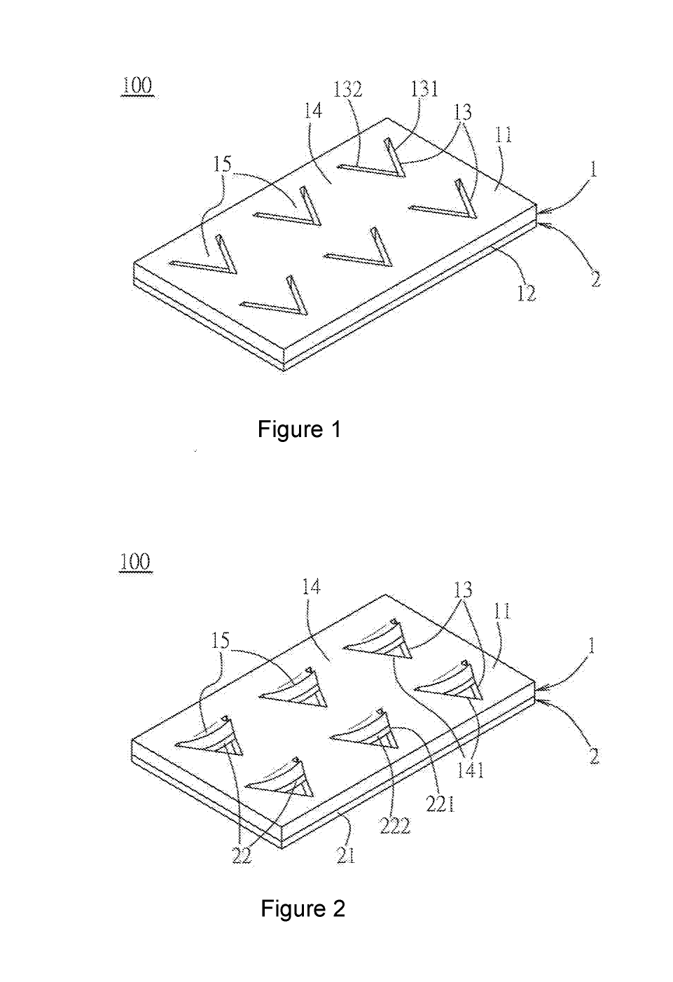

Referring to FIGS. 1, 2, 3, and 4, a first embodiment of a flexible web 100 for clothing according to the disclosure is shown to comprise a fabric substrate layer 1 and a lining piece unit 2. The flexible web 100 may be used alone or in combination with other fabric materials to form clothes, shoe uppers, and the like.

The fabric substrate layer 1 has an outer surface 11, an inner surface 12, and a plurality of slits 13 extending through the outer surface 11 and the inner surface 12 and displaced from each other. Each of the slits 13 includes a first slit segment 131 and a second slit segment 132, which respectively extend along first and second lines that form an angle and which share a common endpoint. In other words, each of the slits 13 has a V-shape. Accordingly, the fabric substrate layer 1 is composed of a main body 14 and a plurality of triangular portions 15 respectively defined by the V-shaped slits 13.

The lining piece unit 2 is provided on the inner surface 12 of the fabric substrate layer 1 and is disposed to be in contact with the skin of a wearer wearing an article of clothing made from the flexible web 100. The lining piece unit 2 is made from an absorbent polymer, and includes a plurality of lining pieces 22 each of which has a first marginal edge 221 and a second marginal edge 222, and each of which is configured such that when bonded to the fabric substrate layer 1, the first and second marginal edges 221, 222 respectively border at the first and second slit segments 131, 132. Examples of the absorbent polymer include, but are not limited to thermoplastic polyurethane, thermoplastic elastomer, and polytetrafluoroethylene.

The first and second marginal edges 221, 222 of each of the lining pieces 22 define an angled contour such that each of the lining pieces 22 is provided with a free triangular portion which is capable of warping. In addition, the lining piece unit 2 is a lining layer 21 which is configured to simulate the fabric substrate layer 1 in shape such that the fabric substrate layer 1 is superimposed on the lining layer 2 and such that the lining layer 21 is formed with a plurality of slits corresponding to the slits 13 of the fabric substrate layer 1.

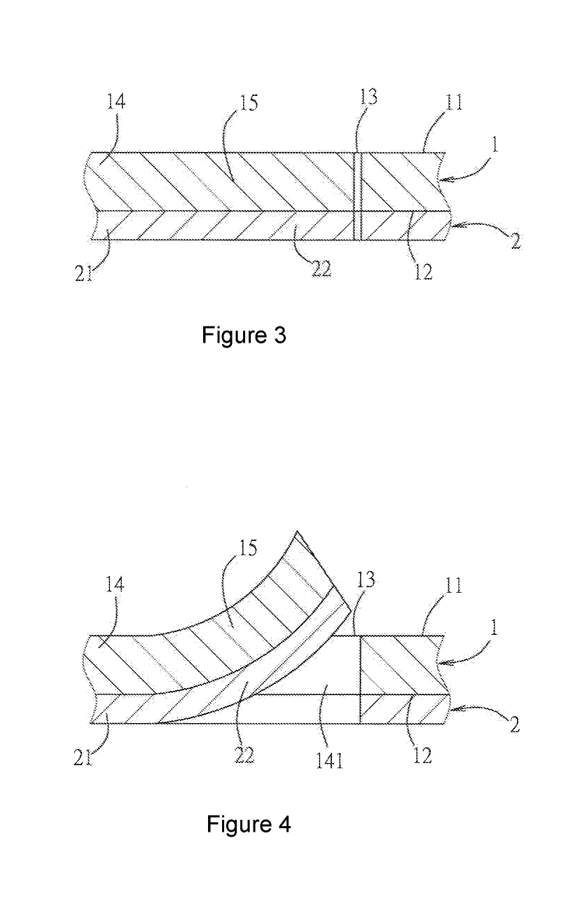

When the lining layer 2, specifically the lining pieces 22, absorbs water moisture (e.g., sweat), the lining pieces 22 will swell such that the lining pieces 22 and the triangular portions 15 warp upwardly to form a plurality of apertures 141 in the flexible web 100, as shown in FIGS. 2 and 4. When the lining layer 2, specifically the lining pieces 22, is in a dry state, the triangular portions 15 are flush with the main body 14, as shown in FIGS. 1 and 3.

Accordingly, when a wearer wearing a sports shirt made from the flexible web 100 of the disclosure is not sweating and the lining piece unit 2 in contact with the wearer's skin is thus in a dry state, the triangular portions 15 are flush with the main body 14, thereby achieving a warmth preservation effect. When the lining piece unit 2 is wet from absorbing the wearer's sweat, the lining pieces 22 and the triangular portions 15 will warp upwardly to form a plurality of apertures 141 in the flexible web 100 such that air may flow through the apertures 141 to thereby provide a breathability effect for the sports shirt.

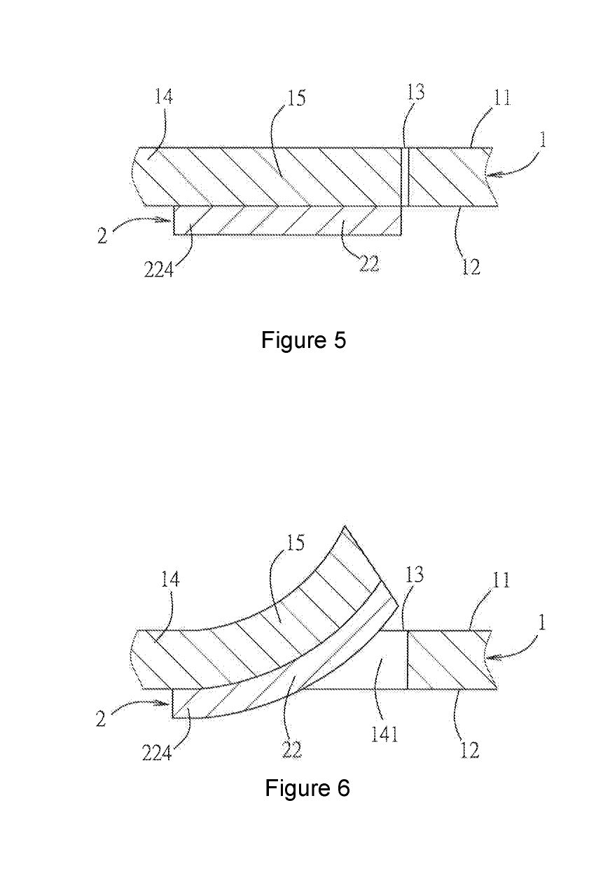

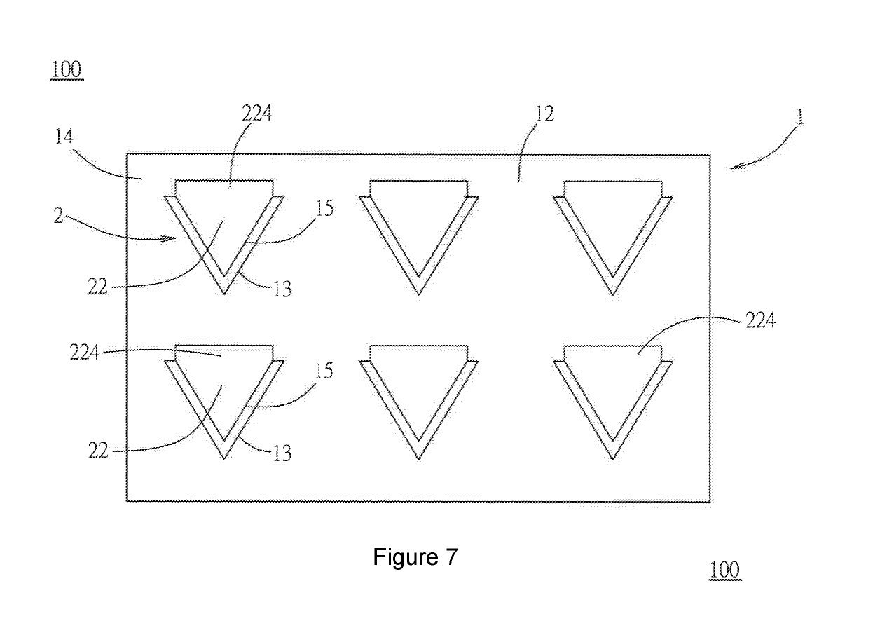

Referring to FIGS. 5, 6, and 7, a second embodiment of a flexible web 100 for clothing according to the disclosure is shown to be similar to the first embodiment except that the lining piece unit 2 in the second embodiment is composed of a plurality of the lining pieces 22 each of which further includes a base strip 224 extending from the free triangular portion and bonded to the fabric substrate layer 1.

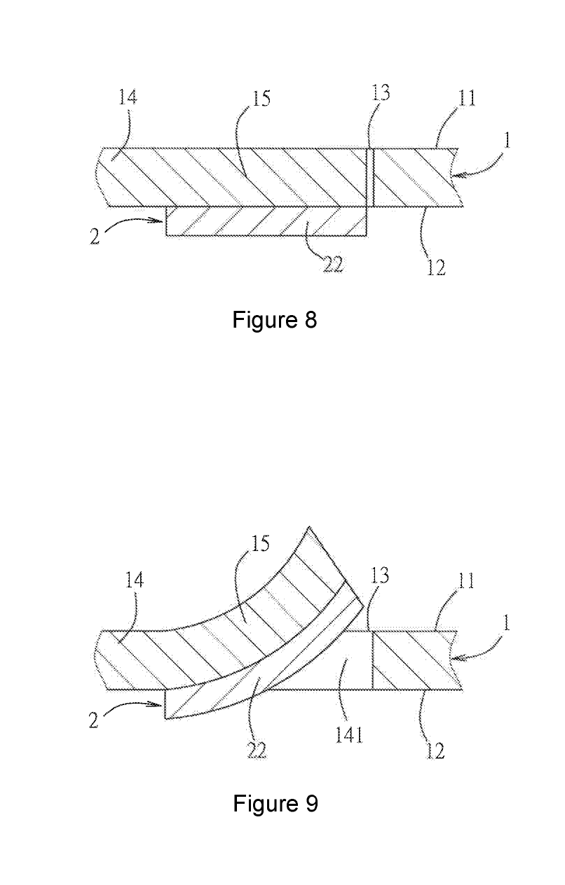

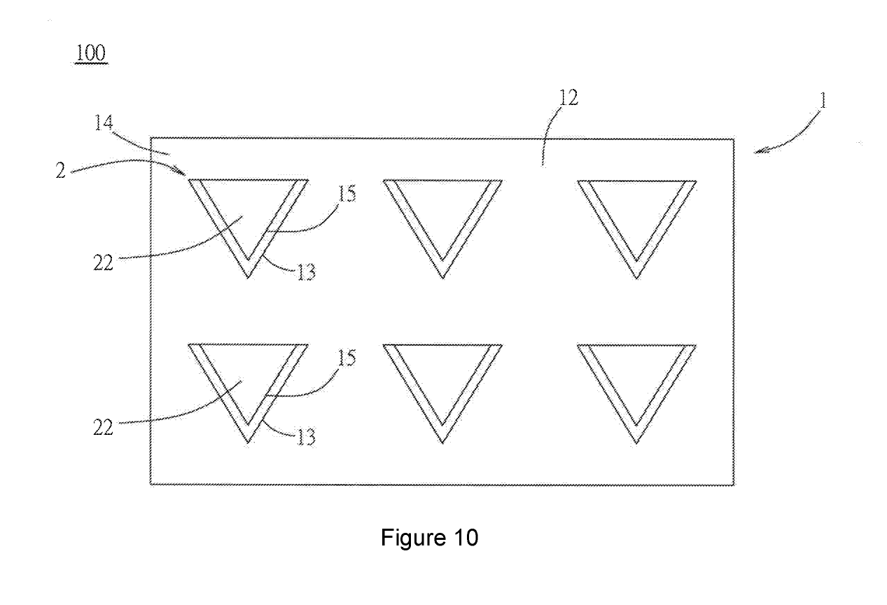

Referring to FIGS. 8, 9, and 10, a third embodiment of a flexible web 100 for clothing according to the disclosure is shown to be similar to the second embodiment except that the lining piece unit 2 in the third embodiment is composed of a plurality of the lining pieces 22 each of which does not include the base strip 224 included in each of the lining pieces 22 in the second embodiment.

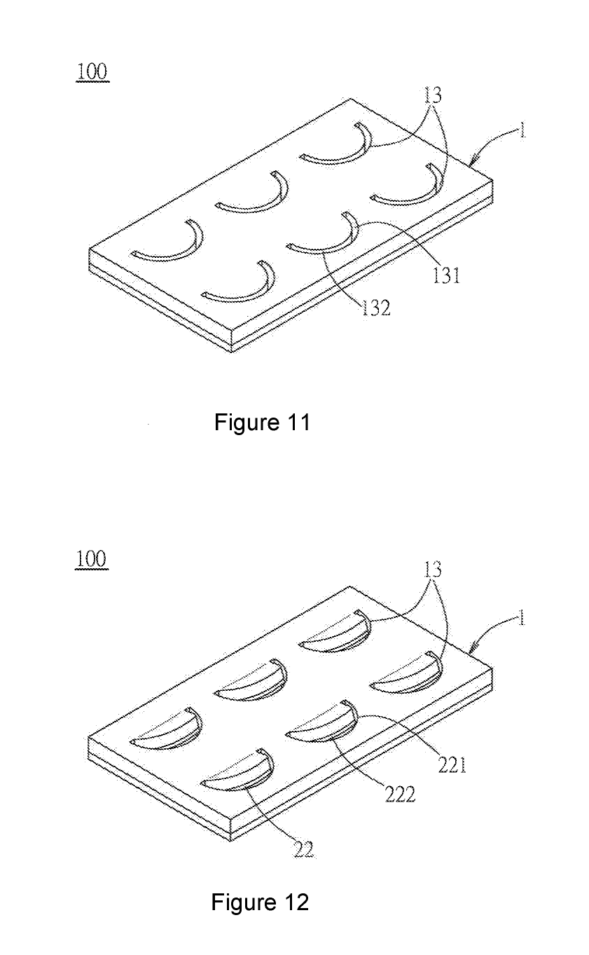

Referring to FIGS. 11 and 12, a fourth embodiment of a flexible web 100 for clothing according to the disclosure is shown to be similar to the first embodiment except that in the fourth embodiment, the first and second slit segments 131, 132 of each of the slits 13 extend to each other along a circumferential direction, and the first and second marginal edges 221, 222 of each of the lining pieces 22 define a semicircular contour such that each of the lining pieces 22 is provided with a free semicircular portion which 13 capable of warping. In addition, each of the lining pieces 22 may further include a base strip (not shown in FIGS. 11 and 12) extending from the free semicircular portion and bonded to the fabric substrate layer 1.

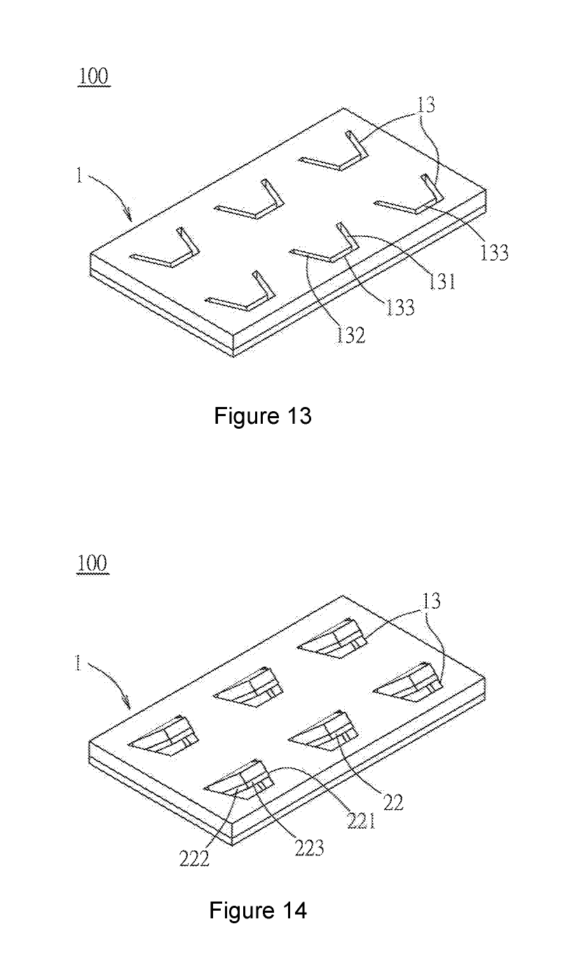

Referring to FIGS. 13 and 14, a fifth embodiment of a flexible web 100 for clothing according to the disclosure is shown to be similar to the first embodiment except that in the fifth embodiment, each of the slits 13 further includes a third slit segment 133 interconnecting the first and second slit segments 131, 132, and each of the lining pieces 22 further has a third marginal edge 223 interconnecting the first and second marginal edges 221, 222 and bordering at the third slit segment 133. Furthermore, in the fifth embodiment, the first, second and third marginal edges 221, 222, 223 of each of the lining pieces 22 define a truncated contour such that each of the lining pieces 22 is provided with a free trapezoid portion which is capable of warping. In addition, each of the lining pieces 22 may further include a base strip (not shown in FIGS. 13 and 14) extending from the free trapezoid portion and bonded to the fabric substrate layer 1.

It should be noted that in addition to the aforesaid, each of the lining pieces 22 may be configured to have other geometrical shapes, for example, a rectangular shape, a polygonal shape, and the like.

In the aforesaid embodiments, the lining piece unit 2 is applied onto the inner surface 12 of the fabric substrate layer 1 by any conventional means such as coating.

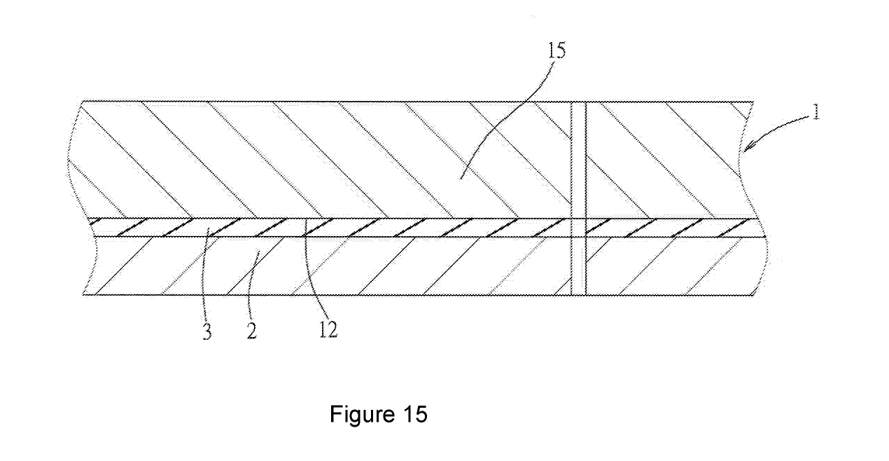

Referring to FIG. 15, a sixth embodiment of a flexible web 100 for clothing according to the disclosure is shown to be similar to the first embodiment except that an adhesive layer 3 is further included and is sandwiched between the fabric substrate layer 1 and the lining piece unit 2. The adhesive layer 3 is made from, for example, a waterproof glue.

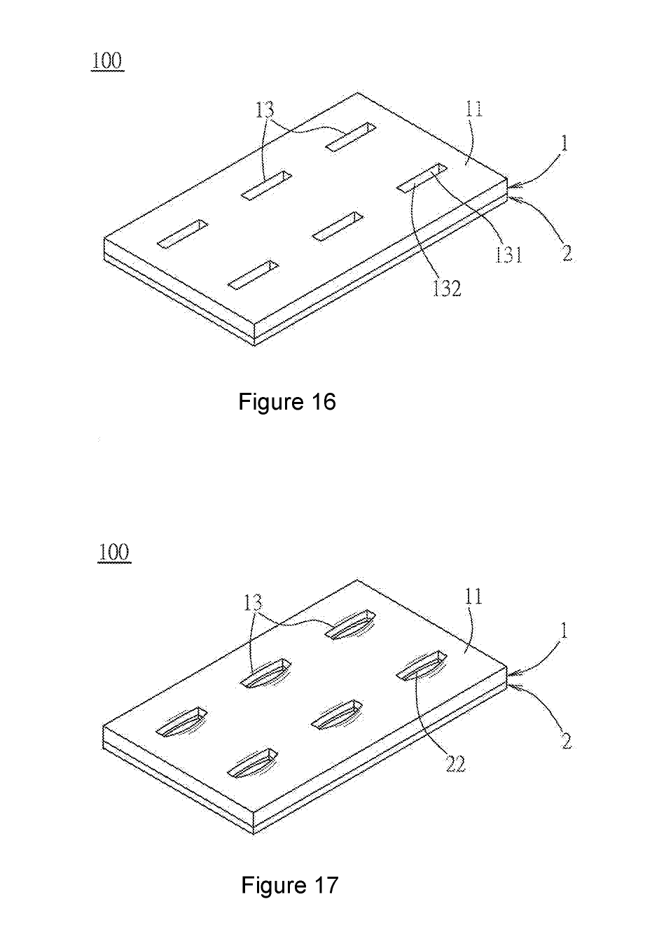

Referring to FIGS. 16 and 17, a seventh embodiment of a flexible web 100 for clothing according to the disclosure is shown to be similar to the first embodiment except that the first and second slit segments 131, 132 of each of the slits 13 in the seventh embodiment are in line with each other. When the lining pieces 22 absorb water moisture (e.g. sweat), a portion of each of the lining pieces 22 proximate to a corresponding one of the slits 13 bulges and the size of each of the slits 13 is thus enlarged.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A flexible web for clothing, comprising:
a fabric substrate layer having a plurality of slits which are displaced from each other and each of which includes a first slit segment and a second slit segment; and
a lining piece unit made from an absorbent polymer and including a plurality of lining pieces each of which has a first marginal edge and a second marginal edge, and each of which is configured such that when bonded to said fabric substrate layer, said first and second marginal edges respectively border at said first and second slit segments.

2. The flexible web for clothing as claimed in claim 1, wherein said first and second slit segments respectively extend along first and second lines which form an angle.

3. The flexible web for clothing as claimed in claim 1, wherein said first and second slit segments are in line with each other.

4. The flexible web for clothing as claimed in claim 1, wherein said first and second slit segments extend to each other along a circumferential direction.

5. The flexible web for clothing as claimed in claim 2, wherein said first and second slit segments share a common endpoint.

6. The flexible web for clothing as claimed in claim 2, wherein each of said silts further includes a third slit segment interconnecting said first and second slit segments, and each of said lining pieces further has a third marginal edge interconnecting said first and second marginal edges and bordering at said third slit segment.

7. The flexible web for clothing as claimed in claim 4, wherein said first and second marginal edges of each of said lining pieces define a semicircular contour such that each of said lining pieces is provided with a free semicircular portion which is capable of warping.

8. The flexible web for clothing as claimed in claim 5, wherein said first and second marginal edges of each of said lining pieces define an angled contour such that each of said lining pieces is provided with a free triangular portion which is capable of warping.

9. The flexible web for clothing as claimed in claim 6, wherein said first, second and third marginal edges of each of said lining pieces define a truncated contour such that each of said lining pieces is provided with a free trapezoid portion which is capable of warping.

10. The flexible web for clothing as claimed in claim 1, wherein said lining piece unit is a lining layer which is configured to simulate said fabric substrate layer in shape such that said fabric substrate layer is superimposed on said lining layer and such that said lining layer is formed with a plurality of slits corresponding to said slits of said fabric substrate layer.

11. The flexible web for clothing as claimed in claim 7, wherein each of said lining pieces further includes a base strip extending from said free semicircular portion and bonded to said fabric substrate layer.

12. The flexible web for clothing as claimed in claim 8, wherein each of said lining pieces further includes a base strip extending from said free triangular portion and bonded to said fabric substrate layer.

13. The flexible web for clothing as claimed in claim 9, wherein each of said lining pieces further includes a base strip extending from said free trapezoid portion and bonded to said fabric substrate layer.

14. The flexible web for clothing as claimed in claim 1, wherein said absorbent polymer is selected from the group consisting of thermoplastic polyurethane, thermoplastic elastomer, and polytetrafluoroethylene.

15. The flexible web for clothing as claimed in claim 1, further comprising an adhesive layer sandwiched between said fabric substrate layer and said lining piece unit.
